(19) United States
(12) Patent Application Publication
(10) Pub. No.: US 2025/0165263 A1
(43) Pub. Date: May 22, 2025

(54) APPLICATION START METHOD, APPARATUS, ELECTRONIC DEVICE, STORAGE MEDIUM AND PROGRAM PRODUCT

(71) Applicant: BEIJING YOUZHUJU NETWORK TECHNOLOGY CO., LTD., Beijing (CN)

(72) Inventor: Lv HE, Beijing (CN)

(21) Appl. No.: 18/837,055

(22) PCT Filed: Feb. 13, 2023
(86) PCT No.: PCT/CN2023/075740

§ 371 Date: Aug. 8, 2024

(30) Foreign Application Priority Data
Feb. 14, 2022 (CN) 202210150641.X

(51) Int. Cl. G06F 9/445; G06F 16/9535

(52) U.S. Cl. CPC G06F 9/4451; G06F 16/9535

(57) ABSTRACT

Provided are an application starting method and apparatus, an electronic device, a storage medium, a computer program product and a computer program, which relate to terminal device technologies. The method includes: in response to a start instruction of an application, obtaining historical browsing information of the application, wherein the historical browsing information includes information generated during a user's browsing of an application; determining a target channel in each channel of the application based on the historical browsing information, and displaying the target channel of the application. Provided are an application start method and apparatus, an electronic device, a storage medium and a program product. Based on historical browsing information about a user corresponding to an application, a target channel preferred by the user in various channels of the application may be presumed, and after the application is started, the electronic device directly displays the target channel, thereby reducing the operations required by the user for switching to the preferred channel, and improving the user experience.

### CROSS REFERENCE TO RELATED APPLICATIONS

This disclosure claims priority to Chinese Patent Application No. 202210150641. X, filed with the Chinese Patent Office on Feb. 14, 2022 and entitled ‘APPLICATION START METHOD, APPARATUS, ELECTRONIC DEVICE, STORAGE MEDIUM AND PROGRAM PRODUCT’, which is incorporated herein by reference in its entirety.

### FIELD

Embodiments of the present disclosure relate to terminal device technologies, and in particular, to an application start method and apparatus, an electronic device, a storage medium, a computer program product, and a computer program.

### BACKGROUND

At present, a plurality of channels is provided in many applications, and a user may operate an application and select any one of the channels for browsing. For example, in some small video applications, the user may choose to browse a recommended channel, and may also choose to browse a friend channel, and the friend channel is used for playing a video uploaded by a friend of the user.

Generally, a channel displayed when an application is started is fixed, for example, in an application for browsing news, a home page is displayed when the application is started generally, and in an application for browsing small videos, a recommended channel is displayed when the application is started generally.

However, the browsing preferences of different users are different, and the channels desired to be browsed are also different. However, in the technical solution of the prior art, a preset channel is fixedly displayed when an application is started, and user experience is poor.

### SUMMARY

Embodiments of the present disclosure provide an application start method and apparatus, an electronic device, a storage medium, a computer program product, and a computer program, so as to reduce operations performed by a user in order to switch channels in an application, thereby improving user experience.

According to a first aspect, an embodiment of the present disclosure provides an application start method, including:
in response to a start instruction of a user for the application, obtaining historical browsing information of the application, the historical browsing information comprising information generated during the user's browsing of the application;
determining a target channel among each channel of the application based on the historical browsing information, and displaying the target channel of the application.

According to a second aspect, an embodiment of the present disclosure provides an apparatus for starting an application, including:
an information obtaining unit configured to obtain historical browsing information about the application in response to a start instruction of a user for the application, the historical browsing information comprising information generated during the user's browsing of the application;
a channel determining unit configured to determine a target channel among channels of the application based on the historical browsing information;
a display unit configured to display the target channel of the application.

According to a third aspect, an embodiment of the present disclosure provides an electronic device, including: at least one processor and a memory;
the memory stores a computer execution instruction;

The at least one processor executes computer execution instructions stored in the memory, causing the at least one processor to execute the application start method according to the first aspect.

According to a fourth aspect, an embodiment of the present disclosure provides a computer readable storage medium, the computer readable storage medium stores a computer execution instruction, when executed by a processor, implements the application start method according to the first aspect.

According to a fifth aspect, an embodiment of the present disclosure provides a computer program product, comprising a computer program, the computer program, when executed by a processor, implements the application start method according to the first aspect.

According to a sixth aspect, an embodiment of the present disclosure further provides a computer program, when executed by a processor, implements the application start method according to the first aspect.

Provided are an application start method and apparatus, an electronic device, a storage medium, a computer program product and a computer program. The method comprises: in response to a start instruction of a user for an application, obtaining historical browsing information about the application, the historical browsing information comprising information generated during the user's browsing of the application; determining a target channel in each channel of the application based on the historical browsing information, and displaying the target channel of the application. Provided are an application start method and apparatus, an electronic device, a storage medium, a computer program product and a computer program, a target channel preferred by the user among each channel of the application may be estimated based on the historical browsing information of the user corresponding to the application. Thus, after the application is started, the electronic device directly displays the target channel, thereby reducing the operations required by the user for switching to the preferred channel, thus, the user experience is improved.

### BRIEF DESCRIPTION OF THE DRAWINGS

To describe the technical solutions in the embodiments of the present disclosure or in the prior art more clearly, the following briefly introduces the accompanying drawings required for describing the embodiments or the prior art, Apparently, the accompanying drawings in the following description show some embodiments of the present disclosure, other drawings may also be obtained according to these drawings without creative efforts.

FIG. 1 is a schematic diagram of an interface when an application is started according to an example embodiment of the present disclosure;

FIG. 2 is a schematic diagram of an interface during application start according to another example embodiment of the present disclosure;

FIG. 3 is a flowchart of an application start method illustrated in an example embodiment of the present disclosure;

FIG. 4 is a flowchart of an application start method according to another example embodiment of the present disclosure;

FIG. 5 is a schematic structural diagram of an application start apparatus illustrated in an example embodiment of the present disclosure;

FIG. 6 is a schematic structural diagram of an application start apparatus illustrated in another example embodiment of the present disclosure;

FIG. 7 is a schematic structural diagram of an electronic device according to an example embodiment of the present disclosure.

### DETAILED DESCRIPTION

In order to make objects, technical solutions and advantages of the embodiments of the present disclosure more apparent, the technical solutions in the embodiments of the present disclosure will be described below in a clearly and fully understandable way in connection with the drawings related to the embodiments of the present disclosure. Obviously, the described embodiments are only a part but not all of the embodiments of the present disclosure. All other embodiments obtained by persons of ordinary skill in the art based on the embodiments of the present disclosure without creative efforts shall belong to the scope of protection of the present disclosure.

FIG. 1 is a schematic diagram of an interface when an application is started according to an example embodiment of the present disclosure.

As shown in FIG. 1, a preset channel is generally set in an application, and when the application is started, the preset channel is entered and the content of the preset channel is displayed.

For example, if there are three channels in the application and the first channel is a preset channel, the first channel may be displayed when the application is started.

However, different users have different preferences, and the selected channels are also different. For example, after a user A opens an application, the user A usually switches channels and selects to browse a second channel.

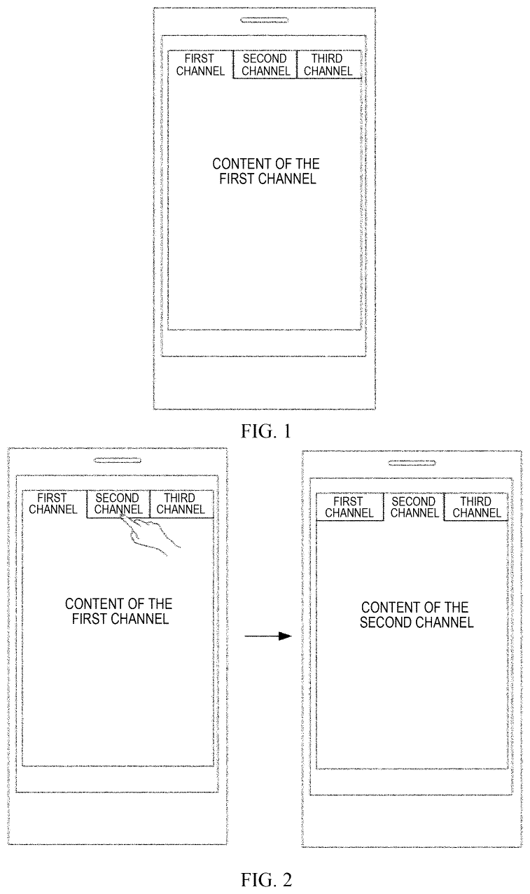

FIG. 2 is a schematic diagram of an interface during application start according to another example embodiment of the present disclosure.

As shown in FIG. 2, if the user does not want to watch the first channel, the user needs to operate the application to enter the second channel.

In some cases, a channel may be switched by operating on an application-enabled interface; however, in some cases, a user needs to perform multiple operations on an application to switch a channel. In any case, a user needs to perform a certain operation to operate an application to enter a channel that the user wants to browse, which increases additional operations and brings poor user experience to the user.

In order to solve the described technical problem, historical browsing information about a user regarding an application is obtained when the application is started, and a channel preferred by the user is further determined based on the historical browsing information; and the channel is directly displayed in response to the application is started, so as to reduce operations performed by the user when switching a channel, and bring a better user experience to the user.

FIG. 3 is a flowchart of an application start method illustrated in an example embodiment of the present disclosure.

As shown in FIG. 3, the present disclosure provides an application start method, including:
Step 301, in response to a start instruction of a user for an application, obtaining historical browsing information about the application, wherein the historical browsing information comprising information generated during the user's browsing of the application.

The method provided in the present disclosure may be executed by an electronic device having a computing capability. An application is installed in the electronic device. For example, the electronic device may be a smart phone, and the application may be an APP installed in the smart phone.

Specifically, the user may operate the electronic device, send an instruction for starting an application to the electronic device, and start the application set therein. For example, the user may click an APP icon on the interface of the smart phone, and then send an instruction for starting the application to the smart phone.

Further, after obtaining the start instruction of the application, the electronic device may respond to the start instruction of the user for the application, and obtain the historical browsing information of the user for the application.

In practical applications, the historical browsing information comprises information generated during the user's browsing of the application, for example, may comprise browsing information before an application exited last time, may also comprise all browsing information when the user applies in the last running process, and may also comprise browsing information when the application runs within a latest period of time. Specifically, the setting may be performed based on a requirement.

In an optional implementation manner, historical browsing information about an application corresponding to a user may be stored in an electronic device, and may also be stored in a background server of the application. If the information is stored in the electronic device, after the electronic device receives an application start instruction, historical browsing information that needs to be used may be obtained from the electronic device. If the information is stored in the background server, the electronic device may access the server to obtain the historical browsing information that needs to be used.

At Step 302, a target channel is determined among channels of the application based on the historical browsing information, and the target channel of the application is displayed.

After obtaining the historical browsing information of the application, the electronic device may determine a channel preferred by the user among each channel of the application based on the historical browsing information, and determine the determined channel as a target channel.

For example, the application comprises five channels, respectively channel 1, channel 2, channel 3, channel 4, and channel 5. The application displays channel 1 by default. If it is determined, based on historical browsing information, that channel 2 is a channel preferred by the user, the electronic device may determine channel 2 as the target channel.

If the channel preferred by the user may not be determined based on the historical browsing information, channel 1 displayed by default may be used as the target channel. For example, when an electronic device runs an application for the first time, a channel preferred by a user may not be predicted based on valid historical browsing information. In this case, a channel displayed by the application by default may be used as a target channel.

Specifically, when starting an application and displaying an application interface, the electronic device may display a target channel in the application. For example, if it is determined that the user prefers channel 2 in the application, the electronic device may display channel 2 when starting the application.

In an optional implementation manner, if the historical browsing information comprises a plurality of historical channels and comprises browsing information of the plurality of historical channels, the electronic device may determine the level of interest of the user in the historical channels, and then select a target channel preferred by the user.

By means of the implementation method, a channel preferred by a user may be displayed after an application is started, without the need for a user to manually switch a channel displayed by the application, thereby reducing the number of operations of the user and improving the user experience.

Provided is an application start method, comprising: in response to a start instruction of a user for an application, obtaining historical browsing information of the application, the historical browsing information comprising information generated during the user's browsing of the application; determining a target channel from channels of the application based on the historical browsing information, and displaying the target channel of the application. The application start method provided in the present disclosure may infer a target channel preferred by a user in various channels of an application based on historical browsing information about the user for the application, and then after the application is started, an electronic device directly displays the target channel, reducing the operations required by the user for switching to the preferred channel, thereby improving the user experience.

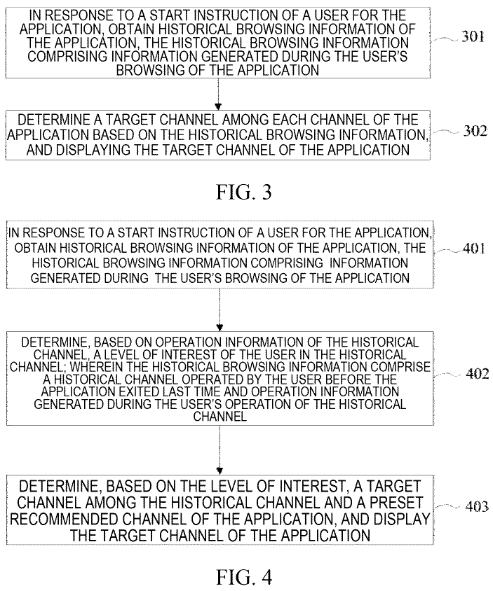

FIG. 4 is a schematic flowchart of an application start method according to another example embodiment of the present disclosure.

As shown in FIG. 4, the present disclosure provides an application start method, comprising:
Step 401, in response to a start instruction of a user for an application, obtaining historical browsing information of the application, wherein the historical browsing information comprises information generated during the user's browsing of the application.

The implementation of Step 401 is similar to that of Step 301, and is not further described.

In step 402, based on operation information about each historical channel, determining the level of interest of the user in the historical channel; the historical browsing information comprises a historical channel operated by the user before the application exited last time and operation information generated during the user's operation of the historical channel.

Specifically, the historical browsing information obtained by the electronic device comprises a historical channel operated by the user before the application exited the last time, for example, if the historical channel operated by the application before the application exited the last time is channel 2, the historical browsing information obtained by the electronic device comprises channel 2.

Further, the historical browsing information further comprises operation information generated by operating the historical channel, for example, may include a browsing duration t and a number of operations.

Since the historical browsing information is the operation information of the user before the application exited the last time, the level of interest of the user in the historical channel corresponding to the operation before the user quits the application may be estimated based on the information, so as to determine whether the user prefers the historical channel.

In a practical application, operation information of a historical channel comprises operation parameters, which may specifically be a plurality of operation parameters. the operation parameters comprise at least one of the following parameters:
stay duration of the historical channel, the quantity of content consumed in the historical channel, the number of clicks on the detail page in the historical channel, the stay duration of the detail page, and the quantity of operations on the content in the historical channel.

The parameters may represent an operation condition of a user on a historical channel, and whether the user is interested in the historical channel may be inferred through the parameters.

In an optional implementation, a weight value may be preset for each operation parameters, and when a level of interest of a user in a historical channel is determined, a preset weight value corresponding to the operation parameters may be obtained, and a value of interest of the user in the historical channel is determined based on the operation parameters and the corresponding weight value.

For example, a weighted sum of the operation parameters may be determined, and the sum may be determined as the user value of interest of the historical channel.

Specifically, if the value of interest is greater than the preset threshold, it is determined that the level of interest of the user in the historical channel is that the user is interested in the historical channel. That is, if the value of interest is greater than the preset threshold, it may be indicated that the user is interested in the historical channel. In this case, it may be determined that the level of interest of the user in the historical channel is that the user is interested in the historical channel.

If the value of interest is less than or equal to the preset threshold, it is determined that the level of interest of the user in the historical channel is that the user is not interested in the historical channel. That is, if the value of interest is less than or equal to the preset threshold, it may be indicated that the user is not interested in the historical channel. In this case, it may be determined that the level of interest of the user in the historical channel is that the user is not interested in the historical channel.

In another implementation, a parameter threshold corresponding to each operation parameter may be preset, and when the level of interest of the user in the historical channel is determined, the preset parameter threshold corresponding to the operation parameter may be obtained.

The operation parameters may be compared with parameter thresholds corresponding thereto, and in response to there being N operation parameters greater than a parameter threshold corresponding to the operation parameters, it is determined that the level of interest of the user in the historical channel is that the user is interested in the historical channel.

Otherwise, determining that the level of interest of the user in the historical channel is that the user is not interested in the historical channel, wherein N is a positive integer less than or equal to the number of operation parameters.

Further, if more operation parameters are greater than the corresponding parameter thresholds, it may be indicated that the operations of the user in the historical channel are relatively frequent, and the user is relatively interested in the historical channel.
Step 403: determining a target channel based on the level of interest in a historical channel and a preset recommended channel of an application, and displaying the target channel of the application.

In practice, if the level of interest indicates that the user prefers the historical channel, the historical channel may be determined as the target channel. If the level of interest indicates that the user does not prefer the historical channel, the preset recommended channel may be determined as the target channel.

The preset recommended channel may be determined by the producer of the application according to requirements.

After the target channel is determined, the electronic device may directly display the target channel of the application after starting the application, without requiring the user to manually switch to the preferred channel.

Specifically, if the level of interest is that the user is interested in the historical channel, the historical channel is determined as the target channel.

In response to the level of interest being that the user is not interested in the historical channel, determining the preset recommended channel of the application as the target channel.

In this implementation, if a historical channel preferred by the user may be inferred based on the user's historical operation, the application may be controlled to display the channel preferred by the user. If the historical channel preferred by the user is not inferred, the application may be controlled to display a default recommended channel, so that the electronic device may display a corresponding channel regardless of whether the historical channel preferred by the user may be inferred.

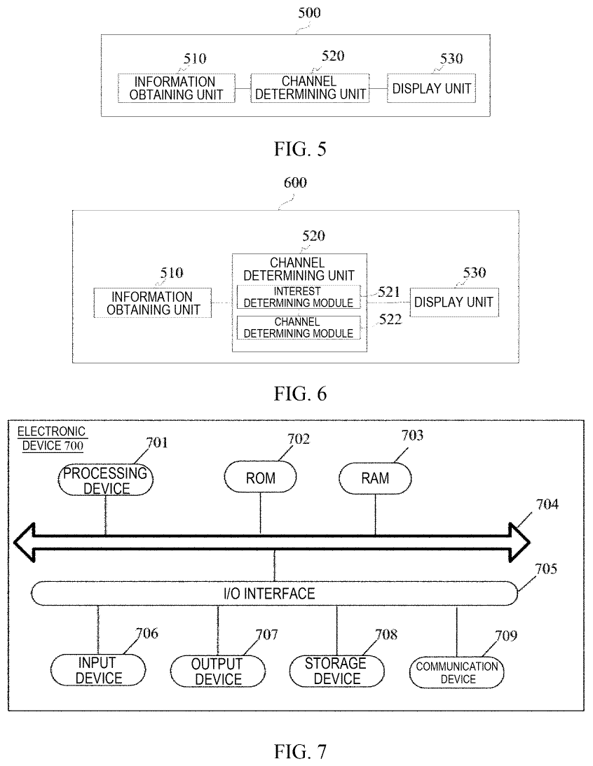

FIG. 5 is a schematic structural diagram of an application start apparatus illustrated in an example embodiment of the present disclosure.

As shown in FIG. 5, the application start apparatus 500 provided in the present disclosure comprises:
an information obtaining unit 510, configured to respond to a start instruction of a user for the application, and obtain historical browsing information of the application, wherein the historical browsing information comprising information generated during the user's browsing of the application;
a channel determining unit 520, configured to determine a target channel from channels of the application based on the historical browsing information;
and a display unit 530, configured to display the target channel of the application.

The application start apparatus provided in the present disclosure may infer a target channel preferred by a user among each channel of an application based on historical browsing information about the user corresponding to the application, and then after the application is started, an electronic device directly displays the target channel, thereby reducing the operations required by the user for switching to the preferred channel, and improving the user experience.

FIG. 6 is a schematic structural diagram of an application start apparatus according to another example embodiment of the present disclosure.

As shown in FIG. 6, the present disclosure provides an application start apparatus 600. On the basis of the described embodiments, the historical browsing information comprises a historical channel operated by the user before the application exited last time and operation information generated during the user's browsing of the application;

The channel determining unit 520 comprises:
an interest determining module 521, configured to determine, based on operation information of each historical channel, a level of interest of the user in the historical channel;
a channel determining module 522, configured to determine a target channel based on the level of interest in the historical channel and the preset recommended channel of the application.

In an optional implementation, the operation information of the historical channel comprises operation parameters;
the operation parameters comprise at least one of the following parameters:
a stay duration of the historical channel, a quantity of content consumed on the historical channel, the number of clicks on a detail page in the historical channel, a stay duration of the detail page, and a quantity of operations performed on content in the historical channel;

The interest determining module 521 is specifically configured to:
obtain a preset weight value corresponding to the operation parameters, and based on the operation parameters and a weight value corresponding to the operation parameters, determine a value of interest of the user in the historical channel;
in response to the value of interest being greater than a preset threshold value, determining that the level of interest of the user in the historical channel is that the user is interested in the historical channel;
in response to the value of interest being less than or equal to the preset threshold, determining that the level of interest of the user in the historical channel is that the user is not interested in the historical channel.

Optionally, the operation information of the historical channel comprises operation parameters;
the operation parameters comprise at least one of the following parameters:
a stay duration of the historical channel, a quantity of content consumed on the historical channel, the number of clicks on a detail page in the historical channel, a stay duration of the detail page, and a quantity of operations performed on content in the historical channel;

The interest determining module 521 is specifically configured to:
obtain a preset parameter threshold corresponding to the operation parameters;
in response to there being N operation parameters greater than a parameter threshold corresponding to the operation parameters, determining that the level of interest of the user in the historical channel is that the user is interested in the historical channel;
otherwise, determining that the level of interest of the user in the historical channel is that the user is not interested in the historical channel; where N is a positive integer less than or equal to the number of operational parameters.

Optionally, the channel determining module 522 is specifically configured to:
in response to the level of interest being that the user is interested in the historical channel, determining the historical channel as the target channel;
in response to the level of interest being that the user is not interested in the historical channel, determining the preset recommended channel of the application as the target channel.

The device provided in this embodiment may be used to execute the technical solutions of the foregoing method embodiments, and implementation principles and technical effects of the device are similar, and are not repeatedly described herein in this embodiment.

Referring to FIG. 7, a schematic structural diagram of an electronic device 700 suitable for implementing an embodiment of the present disclosure is shown. The electronic device 700 may be a terminal device or a server. The terminal device may include, but is not limited to, a mobile terminal such as a mobile phone, a laptop computer, a digital broadcast receiver, a personal digital assistant (Personal Digital Assistant, PDA), a tablet computer (Portable Android Device, PAD), a portable multimedia player (Portable Media Player, PMP), a vehicle-mounted terminal (e. g., a vehicle-mounted navigation terminal), and the like, and a fixed terminal such as a digital TV, a desktop computer, and the like. The electronic device shown in FIG. 7 is merely an example and should not bring any limitation to the functions and scope of use of embodiments of the present disclosure.

As shown in FIG. 7, the electronic device 700 may include a processing device (e. g., central processing unit, graphics processor, etc.) 701 that may perform various suitable actions and processes in accordance with a program stored in a read only memory (ROM) 702 or a program loaded into a random access memory (RAM) 703 from a storage device 708. A variety of programs and data necessary for the operation of the electronic device 700 are also stored in the RAM 703. The processing apparatus 701, the ROM 702, and the RAM 703 are connected to each other via the bus 704. An input/output (Input/Output, I/O) interface 705 is also connected to the bus 704.

In general, the following devices may be connected to the I/O interface 705: an input device 706 including, for example, a touch screen, a touch pad, a keyboard, a mouse, a camera, a microphone, an accelerometer, a gyroscope, or the like; an output device 707 including, for example, a liquid crystal display (LCD), a speaker, a vibrator, or the like; a storage device 708 including, for example, a magnetic tape, a hard disk, or the like; and a communication device 709. Communication device 709 may allow electronic device 700 to communicate wirelessly or wired with other devices to exchange data. While FIG. 7 illustrates an electronic device 700 having various means, it is to be understood that not all of the illustrated means are required to be implemented or provided. More or fewer devices may alternatively be implemented or provided.

In particular, the processes described above with reference to the flowcharts may be implemented as computer software programs in accordance with embodiments of the present disclosure. For example, embodiments of the present disclosure include a computer program product comprising a computer program carried on a computer readable medium. The computer program comprises a program code for executing the method as shown in the flowchart. In such an embodiment, the computer program may be downloaded and installed from the network through the communication device 709, installed from the storage device 708, or installed from the ROM 702. When the computer program is executed by the processing apparatus 701, the described functions defined in the method based on the embodiment of the present disclosure are executed.

It should be noted that the computer readable medium in the present disclosure may be a computer readable signal medium or a computer readable storage medium, or any combination thereof. A computer-readable storage medium may be, for example, but not limited to, an electronic, magnetic, optical, electromagnetic, infrared, or semiconductor system, apparatus, or device, or any suitable combination of the foregoing. More specific examples of the computer readable storage medium may include, but are not limited to, an electrical connection having one or more wires, a portable computer diskette, a hard disk, a random access memory (RAM), a read-only memory (ROM), an erasable programmable read-only memory (Erasable Programmable Read-Only Memory), an EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that may contain or store a program for use by or in connection with an instruction execution system, apparatus, or device. While in the present disclosure, a computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may also be any computer readable medium that is not a computer readable storage medium and that may communicate, propagate, or transport a program for use by or in connection with an instruction execution system, apparatus, or device. Program code embodied on a computer readable medium may be transmitted using any appropriate medium, including, but not limited to, wireline, optical fiber cable, Radio Frequency (RF), etc., or any suitable combination of the foregoing.

The computer readable medium may be included in the electronic device, or may exist separately and not be installed in the electronic device.

The computer readable medium bears one or more programs, and when the one or more programs are executed by the electronic device, the electronic device is enabled to execute the method shown in the foregoing embodiments.

Computer program code for carrying out operations for aspects of the present disclosure may be written in any combination of one or more programming languages, including an object-oriented programming language such as Java, Smalltalk, C++ or the like and conventional procedural programming languages, such as the ‘C’ programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The units involved in the embodiments of the present disclosure may be implemented through software or hardware. The name of a unit does not constitute a limitation to the unit itself in some cases, for example, the first obtaining unit may also be described as “unit to obtain at least two internet protocol addresses”.

The functions described herein above may be performed, at least in part, by one or more hardware logic components. For example, example types of hardware logic components that may be used include, without limitation, Field Programmable Gate Arrays (FPGAs), Application Specific Integrated Circuit (ASICs), Application Specific Standard Products (ASSPs), System on Chip (SOCs), Complex Programmable Logic Devices (CPLDs), etc.

In the context of this disclosure, a machine-readable medium may be tangible media that may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of machine-readable storage media would include an electrical connection based on one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination of the foregoing.

According to a first aspect, based on one or more embodiments of the present disclosure, an application start method is provided, including:
in response to a start instruction of a user for the application, obtaining historical browsing information of the application, wherein the historical browsing information comprising information generated during the user's browsing of the application;
determining a target channel in each channel of the application based on the historical browsing information, and displaying the target channel of the application.

According to one or more embodiments of the present disclosure, the historical browsing information comprises a historical channel operated by the user before the application exited last time and operation information generated when the user operates the historical channel;

The determining a target channel among channels of the application based on the historical browsing information comprises:
determining, based on operation information of the historical channel, a level of interest of the user in the historical channel;
determining, based on the level of interest, a target channel among the historical channel and a preset recommended channel of the application.

According to one or more embodiments of the present disclosure, the operation information of the historical channel comprises operation parameters;
the operation parameters comprise at least one of the following parameters:
a stay duration of the historical channel, a quantity of content consumed on the historical channel, the number of clicks on a detail page of the historical channel, a stay duration of the detail page, and a quantity of operations performed on content of the historical channel;

The determining, based on the operation information of each historical channel, the level of interest of the user in the historical channel comprises:
obtaining a preset weight value corresponding to the operation parameters, and determining, based on the operation parameters and the weight value corresponding to the operation parameters, a value of interest of the user in the historical channel;
in response to the value of interest being greater than a preset threshold value, determining that the level of interest of the user in the historical channel is that the user is interested in the historical channel;
in response to the value of interest being less than or equal to the preset threshold value, determining that the level of interest of the user in the historical channel is that the user is not interested in the historical channel.

According to one or more embodiments of the present disclosure, the operation information of the historical channel comprises an operation parameter;
the operation parameters comprise at least one of the following parameters:
a stay duration of the historical channel, a quantity of content consumed on the historical channel, the number of clicks on a detail page of the historical channel, a stay duration on the detail page, and a quantity of operations performed on content of the historical channel;

The determining, based on the operation information of each historical channel, the level of interest of the user in the historical channel comprises:
obtaining a preset parameter threshold corresponding to the operation parameters;
in response to there being N operation parameters greater than a parameter threshold corresponding to the operation parameters, determining that the level of interest of the user in the historical channel is that the user is interested in the historical channel;
otherwise, determining that the level of interest of the user in the historical channel is that the user is not interested in the historical channel; where N is a positive integer less than or equal to the number of operational parameters.

According to one or more embodiments of the present disclosure, the determining a target channel among the historical channel and the preset recommended channel of the application based on the level of interest comprises:
in response to the level of interest being that the user is interested in the historical channel, determining the historical channel as the target channel;
in response to the level of interest being that the user is not interested in the historical channel, determining the preset recommended channel of the application as the target channel.

According to a second aspect, in one or more embodiments of the present disclosure, an apparatus for starting an application is provided, including:
an information obtaining unit configured to obtain historical browsing information of the application in response to a start instruction of a user for the application, the historical browsing information comprising information generated during the user's operation of the historical channel;
a channel determining unit configured to determine a target channel from channels of the application based on the historical browsing information;
a display unit for displaying the target channel of the application.

According to one or more embodiments of the present disclosure, the historical browsing information comprises a historical channel operated by the user before the application exited last time and operation information generated during the user's operation of the historical channel;

The channel determining unit comprises:
an interest determining module configured to determine, based on operation information of the historical channel, the level of interest of the user from the historical channel;
a channel determining module configured to determine a target channel based on the level of interest in the historical channel and the preset recommended channel of the application.

According to one or more embodiments of the present disclosure, the operation information of the historical channel comprises operation parameters;
the operation parameters comprise at least one of the following parameters:
a stay duration of the historical channel, a quantity of content consumed on the historical channel, the number of clicks on a detail page of the historical channel, a stay duration of the detail page, and a quantity of operations performed on content of the historical channel; the interest determining module is specifically configured to:
obtain a preset weight value corresponding to the operation parameters, and determining, based on the operation parameters and the weight value corresponding to the operation parameters, a value of interest of the user in the historical channel;
in response to the value of interest being greater than a preset threshold value, determining that the level of interest of the user in the historical channel is that the user is interested in the historical channel;
in response to the value of interest being less than or equal to the preset threshold value, determining that the level of interest of the user in the historical channel is that the user is not interested in the historical channel.

According to one or more embodiments of the present disclosure, the operation information of the historical channel comprises operation parameters;
the operation parameters comprise at least one of the following parameters:
a stay duration of the historical channel, a quantity of content consumed on the historical channel, the number of clicks on a detail page in the historical channel, a stay duration of the detail page, and a quantity of operations performed on content in the historical channel;

The interest determining module is specifically configured to:
obtaining a preset parameter threshold corresponding to the operation parameters;
in response to there being N operation parameters greater than a parameter threshold corresponding to the operation parameters, determining that the level of interest of the user in the historical channel is that the user is interested in the historical channel;
otherwise, determining that the level of interest of the user in the historical channel is that the user is not interested in the historical channel; wherein N is a positive integer less than or equal to the number of operational parameters.

According to one or more embodiments of the present disclosure, the channel determining module is specifically configured to:
in response to the level of interest being that the user is interested in the historical channel, determining the historical channel as the target channel;
in response to the level of interest being that the user is not interested in the historical channel, determining the preset recommended channel of the application as the target channel.

According to a third aspect, according to one or more embodiments of the present disclosure, there is provided an electronic device, comprising: at least one processor and a memory;
the memory stores a computer execution instruction;
the at least one processor executes a computer execution instruction stored in the memory, causing the at least one processor to implement the application start method according to the foregoing first aspect and various possible designs of the first aspect.

In a fourth aspect, according to one or more embodiments of the present disclosure, a computer readable storage medium is provided, the computer readable storage medium stores a computer execution instruction, when executed by a processor, implements the application start method according to the first aspect and various possible designs of the first aspect.

In a fifth aspect, an embodiment of the present disclosure provides a computer program product, comprising a computer program, wherein the computer program, when executed by a processor, implements the application start method according to the first aspect and various possible designs of the first aspect.

In a sixth aspect, an embodiment of the present disclosure provides a computer program, when executed by a processor, implements the application start method according to the first aspect and various possible designs of the first aspect.

The foregoing description is merely illustrative of the preferred embodiments of the present disclosure and of the technical principles applied thereto, as will be appreciated by those skilled in the art, The disclosure of the present disclosure is not limited to the technical solution formed by the specific combination of the described technical features, At the same time, it should also cover other technical solutions formed by any combination of the described technical features or equivalent features thereof without departing from the described disclosed concept. For example, the above features and technical features having similar functions disclosed in the present disclosure (but not limited thereto) are replaced with each other to form a technical solution.

In addition, while operations are depicted in a particular order, this should not be understood as requiring that the operations be performed in the particular order shown or in sequential order. Multitasking and parallel processing may be advantageous in certain circumstances. Likewise, while several specific implementation details are included in the above discussion, these should not be construed as limiting the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are merely example forms of implementing the claims.

1. An application start method, comprising:
in response to a start instruction of a user for the application, obtaining historical browsing information of the application, the historical browsing information comprising information generated during the user's browsing of the application;
determining a target channel among each channel of the application based on the historical browsing information, and displaying the target channel of the application.

2. The method according to claim 1, wherein the historical browsing information comprise a historical channel operated by the user before the application exited last time and operation information generated during the user's operation of the historical channel;
determining a target channel among each channel of the application based on the historical browsing information comprises:
determining, based on operation information of the historical channel, a level of interest of the user in the historical channel;
determining, based on the level of interest, a target channel among the historical channel and a preset recommended channel of the application.

3. The method according to claim 2, wherein the operation information of the historical channel comprises operation parameters;
the operation parameters comprise at least one of the following parameters:
a stay duration of the historical channel, a quantity of content consumed on the historical channel, a number of clicks on a detail page of the historical channel, a stay duration of the detail page, and a quantity of operations performed on content of the historical channel;
determining, based on the operation information of the historical channel, the level of interest of the user in the historical channel comprises:
obtaining a preset weight value corresponding to the operation parameters, and determining, based on the operation parameters and the weight value corresponding to the operation parameters, a value of interest of the user in the historical channel;
in response to the value of interest being greater than a preset threshold value, determining that the level of interest of the user in the historical channel is that the user is interested in the historical channel;
in response to the value of interest being less than or equal to the preset threshold value, determining that the level of interest of the user in the historical channel is that the user is not interested in the historical channel.

4. The method according to claim 2, wherein the operation information of the historical channel comprises an operation parameter;
the operation parameters comprise at least one of the following parameters:
a stay duration of the historical channel, a quantity of content consumed on the historical channel, a number of clicks on a detail page on the historical channel, a stay duration of the detail page, and a quantity of operations performed on content of the historical channel;
determining, based on the operation information of the historical channel, the level of interest of the user in the historical channel comprises:
obtaining a preset parameter threshold corresponding to the operation parameters;
in response to there being N operation parameters greater than a parameter threshold corresponding to the operation parameters, determining that the level of interest of the user in the historical channel is that the user is interested in the historical channel;
otherwise, determining that the level of interest of the user in the historical channel is that the user is not interested in the historical channel; wherein N is a positive integer less than or equal to a number of operational parameters.

5. The method according to claim 2, wherein the determining a target channel among the historical channel and the preset recommended channel of the application, based on the level of interest comprises:
in response to the level of interest being that the user is interested in the historical channel, determining the historical channel as the target channel;
in response to the level of interest being that the user is not interested in the historical channel, determining the preset recommended channel of the application as the target channel.

6-10. (canceled)

11. An electronic device, comprising: at least one processor and a memory;
the memory stores a computer execution instruction;
the at least one processor executes a computer execution instruction stored in the memory, causing the at least one processor to implement the application start method comprising:
in response to a start instruction of a user for the application, obtaining historical browsing information of the application, the historical browsing information comprising information generated during the user's browsing of the application;
determining a target channel among each channel of the application based on the historical browsing information, and displaying the target channel of the application.

12. A non-transitory computer readable storage medium, the computer readable storage medium stores a computer execution instruction, when executed by a processor, implements the application start method comprising:
in response to a start instruction of a user for the application, obtaining historical browsing information of the application, the historical browsing information comprising information generated during the user's browsing of the application;
determining a target channel among each channel of the application based on the historical browsing information, and displaying the target channel of the application.

13-14. (canceled)

15. The electronic device according to claim 11, wherein the historical browsing information comprise a historical channel operated by the user before the application exited last time and operation information generated during the user's operation of the historical channel;
determining a target channel among each channel of the application based on the historical browsing information comprises:
determining, based on operation information of the historical channel, a level of interest of the user in the historical channel;
determining, based on the level of interest, a target channel among the historical channel and a preset recommended channel of the application.

16. The electronic device according to claim 15, wherein the operation information of the historical channel comprises operation parameters;
the operation parameters comprise at least one of the following parameters:
a stay duration of the historical channel, a quantity of content consumed on the historical channel, a number of clicks on a detail page of the historical channel, a stay duration of the detail page, and a quantity of operations performed on content of the historical channel;
determining, based on the operation information of the historical channel, the level of interest of the user in the historical channel comprises:
obtaining a preset weight value corresponding to the operation parameters, and determining, based on the operation parameters and the weight value corresponding to the operation parameters, a value of interest of the user in the historical channel;
in response to the value of interest being greater than a preset threshold value, determining that the level of interest of the user in the historical channel is that the user is interested in the historical channel;
in response to the value of interest being less than or equal to the preset threshold value, determining that the level of interest of the user in the historical channel is that the user is not interested in the historical channel.

17. The electronic device according to claim 15, wherein the operation information of the historical channel comprises an operation parameter;
the operation parameters comprise at least one of the following parameters:
a stay duration of the historical channel, a quantity of content consumed on the historical channel, a number of clicks on a detail page on the historical channel, a stay duration of the detail page, and a quantity of operations performed on content of the historical channel;
determining, based on the operation information of the historical channel, the level of interest of the user in the historical channel comprises:
obtaining a preset parameter threshold corresponding to the operation parameters;
in response to there being N operation parameters greater than a parameter threshold corresponding to the operation parameters, determining that the level of interest of the user in the historical channel is that the user is interested in the historical channel;
otherwise, determining that the level of interest of the user in the historical channel is that the user is not interested in the historical channel; wherein N is a positive integer less than or equal to a number of operational parameters.

18. The electronic device according to claim 15, wherein the determining a target channel among the historical channel and the preset recommended channel of the application, based on the level of interest comprises:
in response to the level of interest being that the user is interested in the historical channel, determining the historical channel as the target channel;
in response to the level of interest being that the user is not interested in the historical channel, determining the preset recommended channel of the application as the target channel.
